(19) United States
(12) Patent Application Publication
(10) Pub. No.: US 2024/0421656 A1
(43) Pub. Date: Dec. 19, 2024

(54) Electronically Commutated Motor and Hand-Held Power Tool

(71) Applicant: Robert Bosch GmbH, Stuttgart (DE)

(72) Inventor: Fabian Langbein, Plochingen (DE)

(21) Appl. No.: 18/712,893

(22) PCT Filed: Nov. 2, 2022
(86) PCT No.: PCT/EP2022/080482

§ 371 Date: May 23, 2024

(30) Foreign Application Priority Data
Dec. 17, 2021 (DE) 10 2021 214 612.0

(51) Int. Cl. H02K 7/08; H02K 5/173; H02K 7/14; H02K 9/06; H02K 11/21; H02K 21/24

(52) U.S. Cl. CPC H02K 7/085; H02K 5/1735; H02K 7/145; H02K 9/06; H02K 11/21; H02K 21/24

(57) ABSTRACT

In the case of an electronically commutated motor with a disc-shaped rotor which has an associated magnetization means and a rotor shaft, and with an annular stator, on which a plurality of stator teeth are provided, wherein each stator tooth is provided with a stator tooth winding, each of which is configured to interact magnetically with the magnetization means of the rotor, and wherein the rotor shaft reaches through the stator in the axial direction, the rotor shaft is mounted rotatably via at least two bearings which are arranged on the rotor shaft directly next to one another in the axial direction of the rotor shaft.

### PRIOR ART

The invention relates to an electronically commutated motor with a disc-shaped rotor which has an associated magnetization means and a rotor shaft, and with an annular stator on which a plurality of stator teeth are provided, wherein each stator tooth is provided with a stator tooth winding which is configured in each case to interact magnetically with the magnetization means of the rotor, and wherein the rotor shaft reaches through the stator in the axial direction.

A special type of electronically commutated motor is the so-called axial flux machine or transverse flux machine. In this design, a corresponding rotor is disc-shaped, resulting in a high power density in combination with a short design. Due to the disc-shaped rotor, the magnetic forces act on a longer lever arm in relation to the rotor's axis of rotation, allowing the motor to achieve a high torque. The disc-shaped rotor of the axial flux machine is generally supported by two ball bearings, one of which is arranged in the region of an associated stator and another on the opposite side of a rotor plate pack of the rotor. The axial length of the axial flux machine is increased due to the double-sided bearing of the disc-shaped rotor.

### DISCLOSURE OF THE INVENTION

The invention relates to an electronically commutated motor with a disc-shaped rotor which has an associated magnetization means and a rotor shaft, and with an annular stator on which a plurality of stator teeth are provided, wherein each stator tooth is provided with a stator tooth winding which is configured in each case to interact magnetically with the magnetization means of the rotor, and wherein the rotor shaft reaches through the stator in the axial direction. The rotor shaft is rotatably mounted by at least two bearings arranged directly next to each other on the rotor shaft in the axial direction of the rotor shaft.

Inexpensive standard bearings can therefore be used in the motor according to the invention in order to ensure a reliable bearing of the rotor shaft even in the case of higher radial forces. In addition, the axially directly adjacent bearings allow simple compensation of thermally induced mechanical stresses in the axial direction to a certain extent. The magnetization means of the rotor can be configured as a continuous permanent magnetic disc with zoned north and south poles. Alternatively, a plurality of correspondingly magnetized permanent magnet segments can be provided to realize the north and south poles of the rotor.

Preferably, the at least two bearings are arranged axially at least in some regions within the stator or axially between the rotor and the stator.

This makes it possible to achieve a particularly short design in the axial direction or a favorable, even weight distribution on both sides in relation to the bearings.

Preferably, the magnetization means of the disc-shaped rotor is formed at least in some regions on a first end face of a rotor base body, wherein the first end face faces the stator teeth and an axial air gap is formed between the first end face and the stator teeth.

The air gap results in only low magnetic losses.

Preferably, the at least two bearings are each configured as roller bearings, in particular as ball bearings or roller bearings.

This ensures that the rotor runs with particularly low friction. In addition to absorbing higher radial forces—albeit to a lesser extent—the ball bearings also allow significant axial forces to be absorbed.

Preferably, the rotor shaft has a radially outwardly directed collar section for one-sided axial positional locking of at least two inner rings of the at least two bearings.

This provides a simple one-sided axial positional locking of the rotor on the rotor shaft.

Preferably, the stator has an annular stator base body with a central opening, wherein a sleeve-like bearing bracket is accommodated in the central opening, and at least two outer rings of the at least two bearings are accommodated in a through-opening of the bearing bracket, wherein the stator base body forms a magnetic stator return.

The bearing bracket ensures reliable mounting of the rotor and easy installation of the motor. The stator base body also closes the magnetic circuit of the motor in the region of the stator.

Preferably, the rotor base body forms a magnetic rotor return for the magnetization means of the rotor.

This closes the magnetic circuit in the region of the rotor.

Preferably, a fan wheel is arranged at a first end of the rotor shaft, wherein the fan wheel bears axially against a second end face, directed away from the first end face of the rotor, at least in some regions.

Active cooling by means of the radial fan wheel reliably prevents the electronically commutated motor from overheating, at least to a large extent, under all practical operating conditions. Cool ambient air drawn in by the fan wheel flows into the interior of the motor between two directly adjacent stator tooth windings on the circumference side and then passes through a spoke structure of the rotor base body into the fan wheel and from there radially outwards again into the external environment. Optionally, an additional air flow can be set up between the bearing bracket and a stator base body.

Preferably, a second end of the rotor shaft has at least one signal transmitter for detecting the position of the rotor in relation to the stator and/or an output gear.

This enables electronic commutation of the motor by means of corresponding control and/or regulation electronics. By means of an optional output element, such as an output gear or the like, a torque emitted by the electronically commutated motor can be transmitted with low loss to a machine part to be driven, such as a drill chuck, an impact mechanism, a sawmill or the like. The signal transmitter can be integrated into the output element if necessary.

According to one embodiment, the electronically commutated motor is configured without a housing.

As a result, it is possible to integrate the electronically commutated motor into a target application, such as a drill, screwdriver, saw, router or similar, in a particularly space- and weight-saving manner.

Furthermore, the invention relates to a hand-held power tool with at least one electronically commutated motor as described above.

This makes it possible to provide a hand-held power tool with a short axial length and a high output torque at the same time. Thus, an appropriate hand-held power tool may be provided in an easy and straightforward manner.

### BRIEF DESCRIPTION OF THE DRAWINGS

The invention is explained in more detail in the following description with reference to the exemplary embodiments shown in the drawings. Shown are:

FIG. 1 a schematic longitudinal section through an electronically commutated motor configured as an axial flux machine,

FIG. 2 a detailed perspective view of a stator of the electronically commutated motor of FIG. 1, and

FIG. 3 a detailed perspective view of a rotor of the electronically commutated motor of FIG. 1.

### DESCRIPTION OF THE EXEMPLARY EMBODIMENTS

Elements having the same or a comparable function are provided with the same reference characters in the drawings and are described in detail only once.

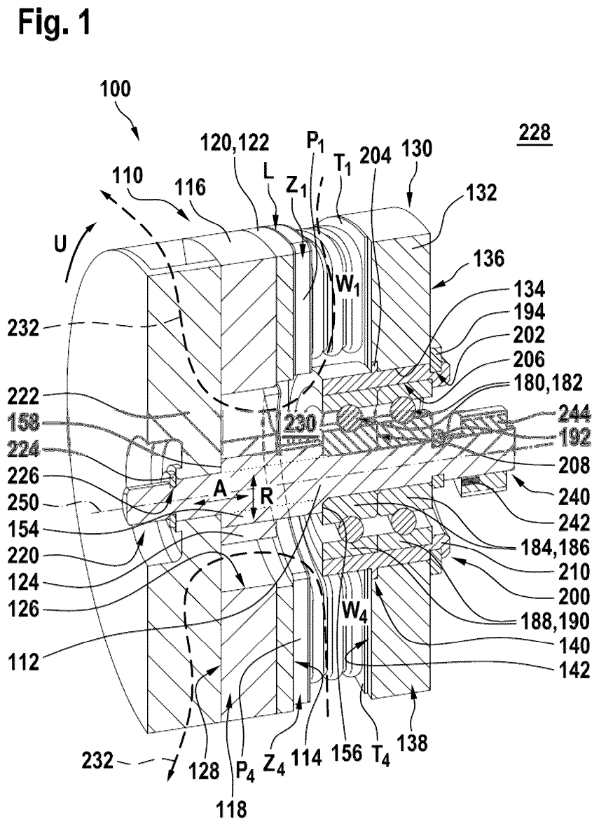

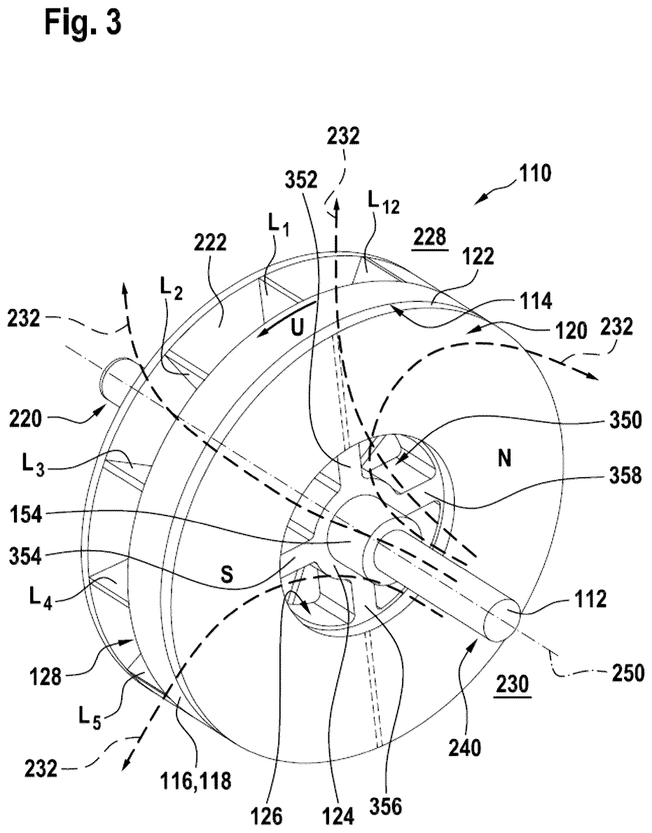

FIG. 1 shows an example of an electronically commutated motor 100 configured as an axial flux machine. The electronically commutated motor 100 preferably has, among other things, a disc-shaped rotor 110 with a rotor shaft 112. A magnetization means 120 is preferably provided on the rotor 110. The magnetization means 120 can be realized, for example, by a sintered magnet arrangement or with permanent magnetic particles embedded in a plastic matrix or, finally, with appropriately magnetized particles. The magnetization means 120 of the rotor 110 can, as shown here only as an example, be configured as a magnet arrangement with a circumferentially continuous, permanent-magnetic disc 122 with zoned or correspondingly magnetized north and south poles not shown here (cf. in particular FIG. 3; reference signs N and S), e.g., in the manner of a diametrically magnetized disc magnet. Alternatively, a plurality of correspondingly magnetized, “pie-shaped” permanent magnet segments can be provided to realize the permanently excited north and south poles of the rotor 110 (not shown).

Furthermore, the electronically commutated motor 100 preferably has an annular stator 130, on which a plurality of stator teeth are provided, of which only the stator teeth Z_{1,4} are visible here, wherein each stator tooth carries a stator tooth winding, of which only the two stator tooth windings W_{1,4} are also shown in FIG. 1. By energizing individual or groups of stator tooth windings of the stator 130 in a rotational direction U, for example, the rotor 110 is set in a corresponding rotational movement around the rotor shaft 112 in relation to the stator 130.

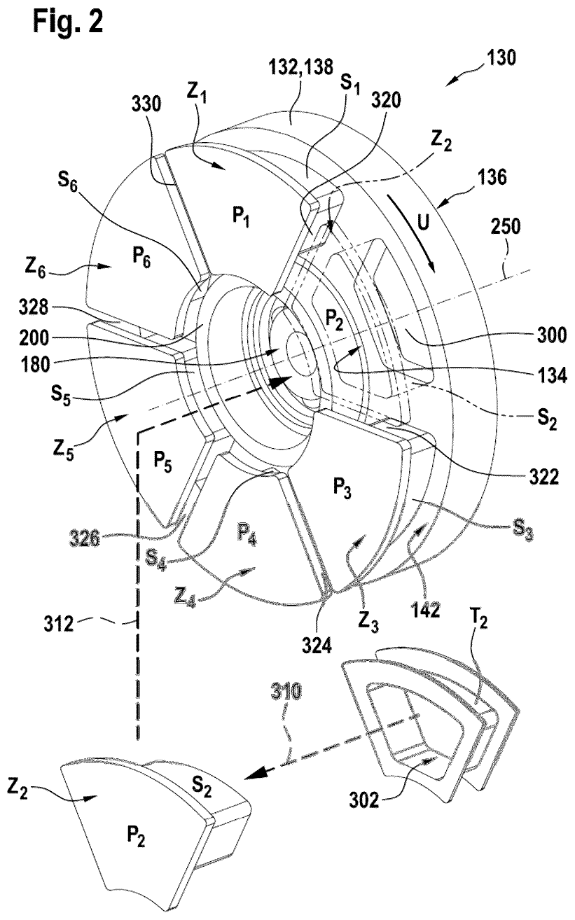

The stator tooth windings, preferably formed with enameled copper wires, are not wound directly onto the stator teeth. Instead, each stator tooth is preferably fitted with an associated winding bracket made of plastic, to which the stator tooth windings are attached. The winding brackets with the stator windings wound on them can be slid onto the respective stator teeth during an installation process of the electronically commutated motor 100 after the winding process has been completed, resulting in an efficient manufacturing process. Only the stator teeth Z_{1,4} with the winding brackets T_{1,4} and the stator tooth windings W_{1,4} wound on them are shown here. Each of the stator teeth Z_{1,4} has an illustratively flat pole piece P_{1,4} pointing in the direction of the magnetization means 120. The same applies to the other stator teeth not shown here. Between the pole pieces P_{1,4} and the magnetization means 120 or the permanent-magnet disc 122 there remains an axial air gap L, preferably as narrow as possible, in order to reduce the magnetic losses. All pole pieces of the stator 130 lie in an imaginary plane, wherein a radially outwardly directed pole piece gap remains between each two directly adjacent pole pieces (see FIG. 2; reference signs P_{1, . . . ,6} and 320 through 330).

According to the invention, the rotor shaft 112 is rotatably mounted with the aid of two bearings 180, 182 arranged axially directly next to one another on the rotor shaft 112, preferably within the annular stator 130. The bearings 180, 182 are preferably designed as anti-friction bearings, in particular as ball bearings, roller bearings, needle bearings or the like, which are not labeled for the sake of a better graphic overview. The bearings 180, 182 can be positioned axially at least in some regions completely within the stator 130 or axially between the disc-shaped rotor 110 and the stator 130. The electronically commutated motor 100 is illustratively and exemplarily constructed rotationally symmetrically to a longitudinal central axis 250, which runs parallel to an axial direction A, while a radial direction R is defined as running orthogonally to the longitudinal central axis 250.

The magnetization means 120 is preferably arranged at least in some regions on a first end face 114 of a disc-shaped rotor base body 116, which at the same time forms a magnetic rotor return 118 for the magnetization means 120 or the permanent-magnetic disc 122. The rotor base body 116 can be formed with solid steel, with stacked electrical steel sheets or with an SMC material (SMC=“Soft Magnetic Composite”). Preferably, the rotor base body 116 is connected to the rotor shaft 112 in a non-rotating and non-sliding manner, preferably pressed onto the rotor shaft 112 in a non-positive manner.

The rotor shaft 112 preferably has a radially outwardly directed collar section 154, the stator-side shoulder 156 of which serves, among other things, for axial positional locking of two inner rings 184, 186 of the two bearings 180, 182 on one side. The collar section 154 can be realized integrally to the rotor shaft 112 or by means of a force-fitted hollow cylinder. By means of a locking element 192, in particular in the form of a locking ring or the like, the axial positional locking of the inner rings 184, 186 of the bearings 180, 182 takes place preferably in a second axial direction. The inner rings 184, 186 and thus the bearings 180, 182 are axially positionally locked on both sides of the rotor shaft 112 by the collar section 154 of the rotor shaft 112 and the securing element 192.

A hub 124 of the rotor 110 is preferably connected to the rotor shaft 112 in a rotationally and slidingly fixed manner, for example by pressing on or the like, and preferably closes axially flush with a rotor-side shoulder 158 of the collar section 154. For its part, the hub 124 is exemplarily connected to or integrally with a rotor passage opening 126 of the rotor base body 116 by means of a radially outwardly directed spoke structure not shown here (cf. in particular FIG. 2).

The preferably also annular stator 130 has, by way of example, an annular stator base body 132 with an axially continuous, central opening 134. In the central opening 134 of the stator base body 132, a sleeve-like and optional bearing bracket 200 formed, for example, with a plastic material is preferably arranged, preferably pressed in. Alternatively or additionally, a further locking element 194 can be provided, which is located in an end-side and radially outwardly open annular groove 202 of the bearing bracket 200 and preferably comes into axial play-free contact with a flat rear side 136 of the stator base body 132. A radially outwardly directed, circumferential projection 204 is formed axially approximately centrally on the bearing bracket 200 or at an axial joint 208 between the two bearings 180, 182 and serves as a further axial stop, so that the bearing bracket 200 is accommodated axially locked in position on both sides in the central opening 134 of the stator base body 132. The circumferential projection 204 of the bearing bracket 200 lies in an annular groove 140 of an end face 142 of the stator base body 132, which is open on one side. The winding brackets can at least in some regions cover the annular groove 140 in the stator base body 132, so that the radially outwardly directed projection 204 of the bearing bracket 200 is fixed on both sides in the axial direction A within the annular groove 140, which is otherwise open on one side in the direction of the rotor 110, in addition to being pressed in.

Due to the plastic design of the bearing bracket 200, it magnetically isolates the two bearings 180, 182 from a magnetic stator return 138 or increases the magnetic resistance between the components.

Two outer rings 188, 190 of the bearings 180, 182 are preferably accommodated in a central through-opening 206 of the optional bearing bracket 200, i.e., in particular pressed in with a force fit, wherein a radially inwardly directed edge 210 of the bearing bracket 200, which is formed axially in the region of the annular groove 202, serves as a rearward axial stop. The stator base body 132 may be formed with a wound electrical steel sheet, an SMC material or the like and forms the stator return 138 with a low magnetic resistance.

At a first end 220 of the rotor shaft 112, for example, an optional (radial) fan wheel 222 formed with a plastic material is arranged in a rotationally and slidingly fixed manner. The fan wheel 222 lies axially, at least in some regions, against a second end face 128 of the rotor base body 116, which is directed away from the first end face 114. The rotor-side shoulder 158 of the collar section 154 of the rotor shaft 112 and an optional locking element 224, which is located in an annular groove 226 in the rotor shaft 112, serve as an axial stop on both sides for the fan wheel 222. The fan wheel 222 draws in cold air from an external environment 228 of the electronically commutated motor 100. An air flow 232 flows between two circumferentially directly adjacent stator tooth windings, reaches an interior 230 of the electronically commutated motor 100, flows from there through the spoke structure of the rotor base body 116 into the fan wheel 222 and from there back into the external environment 228 of the electronically commutated motor 100. As a result, the waste heat generated in the interior 230 of the electronically commutated motor 100 is very effectively dissipated into the external environment 228. In addition, a further axial air flow can be provided between the bearing bracket 200 and the stator base body 132.

At a second end 240 of the rotor shaft 112, which is directed away from the first end 220 of the rotor shaft 112, a signal transmitter 242 for detecting a rotation angle of the rotor 110 in relation to the stator 130 by means of a sensor, which is not shown, in conjunction with an electronic control and/or regulating device, which is likewise not shown, is provided here by way of example only. Alternatively, suitable sensors can be arranged, for example, on the winding brackets T_{1,4} or corresponding stator teeth and enable position detection of the rotor 110 by means of detection of the stray field of the rotor 110. Further, the second end 240 of the rotor shaft 112 may include an optional output member, such as an output gear 244 or the like, for rotationally driving a machine component not shown. The signal transmitter 242 may be integrated into the output element.

FIG. 2 shows the stator 130 of the electronically commutated motor 100 of FIG. 1. In the central opening 134 of the stator base body 132 of the stator 130, the bearing bracket 200 with the bearing 180 accommodated therein is secured by press-fitting. The stator 130 and the bearing bracket 200 with the bearing 180 are illustratively and exemplarily constructed rotationally symmetrically to the longitudinal central axis 250.

In the end face 142 of the stator base body 132, only six exemplary “pie-shaped” or circular ring sector-shaped recesses are formed here, arranged uniformly spaced from one another in a circumferential direction U, of which only one recess 300 is designated here as representative of all the other identically formed recesses. The trough-like recesses serve to accommodate and fasten legs S_{1, . . . ,6} of the six stator teeth Z_{1, . . . ,6} of the electronically commutated motor 100 of FIG. 1, which are only provided here by way of example. The legs S_{1, . . . ,6} of the stator teeth Z_{1, . . . ,6} can each be configured to be at least slightly press-fit to the recesses and can, for example, be glued, welded, soldered, caulked or firmly connected to them in some other way for a secure connection. For this purpose, the legs S_{1, . . . ,6} have a cross-sectional geometry that is complementary to the recesses in some regions.

Furthermore, a winding bracket is attached to each stator tooth Z_{1, . . . ,6}, of which only the winding bracket T₂ is shown here in a state removed from the stator tooth Z₂ for the sake of clarity. The winding brackets are used, among other things, to accommodate the stator tooth windings, which are preferably made of enameled copper wire, and to mechanically protect them from electrical short circuits, wire breaks, etc. (see FIG. 1, in particular reference signs T_{1,4} and W_{1,4}). The stator base body 132 forms the magnetic return 138 for the magnetic flux generated by the stator tooth windings W_{1, . . . ,6} when energized.

The winding brackets and the winding bracket T₂ shown here as representative of all the others each have a through-opening which is shaped to complement the exemplary circular ring sector-shaped cross-sectional geometry of the legs S_{1, . . . ,6} of the stator teeth Z_{1, . . . ,6} in such a way that the winding brackets can be easily pushed or pushed onto the associated legs S_{1, . . . ,6} of the stator teeth Z_{1, . . . ,6} in a press-fit or “sucking” manner, as indicated by the arrow 310. In FIG. 2, only one through-opening 302 of the winding bracket T₂ is designated as representative of all other, identically designed through-openings of the remaining winding brackets not shown.

Between two pole pieces P_{1,2}, P_{2,3}, P_{3,4}, P_{4,5}, P_{5,6} and P_{6,1} lying directly next to each other in the circumferential direction U, there is an illustratively narrow radial gap 320, 322, 324, 326, 328 and 330 for magnetic isolation.

In the illustration in FIG. 2, the second stator tooth Z₂ is shown in the remounted position for the sake of better graphic representation. The leg S₂ of the stator tooth Z₂ is connected, in particular bonded, to the associated recess 300 within the end face 142 of the stator base body 132 of the stator 130 after the winding bracket T₂ has been fitted, which is schematically indicated by the dotted outline of the stator tooth Z₂ and symbolized by the arrow 312. The same procedure is followed for the installation of all other stator teeth Z_{1, . . . ,6} of the stator 130 already connected to the stator 130 in the illustration in FIG. 2.

FIG. 3 shows the rotor 110 of the electronically commutated motor 100 of FIG. 1. The rotor base body 116 of the rotor 110, which forms the magnetic rotor return 118, is preferably fixed to the collar section 154 of the rotor shaft 112 in a rotationally and slidingly fixed manner by means of the hub 124, for example by pressing it on. The magnetic rotor return 118 has the lowest possible magnetic resistance.

By way of example only, the hub 124 of the rotor base body 116 is connected to the rotor through-opening 126 by means of a spoke structure 350. Preferably, the hub 124, the spoke structure 350 and the rotor base body 116 form an integral or one-piece unit, which may for example be solidly manufactured with a steel or with a SMC sintered material. The spoke structure 350 here only has, by way of example, four spokes 352, 354, 356, 358, each offset by 90° to one another in the circumferential direction U. The rotor shaft 112 has the first and second ends 220, 240, wherein the fan wheel 222 is arranged in the region of the first end 220 of the rotor shaft 112 so as to be resistant to rotation and sliding and in this case bears at least in some regions against the second end face 128 of the rotor base body 116. The fan wheel 222 is formed with a plastic material and in this example only has twelve radially outwardly directed and straight blades L_{1, . . . ,12}, which are preferably evenly spaced apart in the circumferential direction U. Of the twelve slats L_{1, . . . ,12}, only the seven visible slats L_{1, . . . ,5} and L₁₂ are labeled here.

Due to the axially open spoke structure 350, the air flow 232 drawn in by the rotating fan wheel 222 from the interior 230 of the electronically commutated motor 100 or the stator 130 of FIG. 1, which is not shown here, can flow axially through the rotor base body 116—at least in sections coaxially to the rotor shaft 112—and from there returns to the external environment 228 of the motor 100 in a radial outward movement. This course of the air flow 232 leads to an effective dissipation of the thermal waste heat released primarily in the region of the stator with its stator tooth windings. To further optimize the dissipation of heat loss, the electronically commutated motor 100 is preferably configured without a housing.

The magnetization means 120 is illustratively realized by a magnet arrangement with a continuously formed, permanent-magnetic as well as annular disc 122 or thicker layer, which is formed at least in some regions on the first end face 114 of the rotor base body 116 or is configured as a separate component and is firmly connected thereto. To form only one north pole N and one south pole S, for example, the disc 122 is magnetized in zones, i.e., in the form of circular ring segments.

Alternatively, two or more individual circular ring sector-shaped or “pie-shaped” permanent magnet segments (not shown) may be positioned and attached to the first end face 114 of the rotor base body 116 in accordance with the geometric arrangement of poles N and S illustrated herein.

Moreover, the design of the stator 130 and the rotor 110 follows the usual design rules of an electronically commutated, permanently excited synchronous machine, which are sufficiently familiar to a specialist working in the field of electrical machines, so that a more detailed explanation of technical details is dispensed with at this point for the sake of brevity and brevity of the description.

An electric hand-held power tool not shown in the drawings, which is equipped with the electronically commutated (axial flux) motor according to the invention, in conjunction with the compact, single-sided bearing of the rotor, initially enables a comparatively short axial design of the hand-held power tool. As a result, the hand-held power tool can also be used in otherwise inaccessible regions. At the same time, the motor generates a significantly higher torque compared to a conventional radial flux motor, which can be transmitted via an intermediate gearbox to an insert tool used in conjunction with the hand-held power tool, such as a drill, a screwdriver bit, a milling cutter, a saw blade or similar. This allows, for example, drills or milling cutters with a larger diameter to be used.

1. An electronically commutated motor, comprising:
a disc-shaped rotor, which has an associated magnetization component and a rotor shaft; and
an annular stator, on which a plurality of stator teeth is provided, each of the plurality of stator teeth provided with a respective stator tooth winding, each of which is configured to interact magnetically with the magnetization component of the rotor,
wherein
the rotor shaft reaches through the stator in the axial direction, and
the rotor shaft is rotatably mounted on the rotor shaft via at least two bearings arranged directly next to one another in the axial direction of the rotor shaft.

2. The electronically commutated motor according to claim 1, wherein the at least two bearings are arranged axially at least in some regions within the stator or axially between the rotor and the stator.

3. The electronically commutated motor according to claim 1, wherein:
the magnetization component of the disc-shaped rotor is formed at least in some regions on a first end face of a rotor base body; and
the first end face faces the plurality of stator teeth and an axial air gap is formed between the first end face and the plurality of stator teeth.

4. The electronically commutated motor according to claim 1, wherein each of the at least two bearings are configured as one of ball bearings and roller bearings.

5. The electronically commutated motor according to claim 4, wherein the rotor shaft has a radially outwardly directed collar section for one-sided axial positional locking of at least two inner rings of the at least two bearings.

6. The electronically commutated motor according to claim 5, wherein:
the stator has an annular stator base body with a central opening; a sleeve-like bearing bracket is accommodated in the central opening and at least two outer rings of the bearings are accommodated in a through-opening of the bearing bracket; and
the stator base body forms a magnetic stator return.

7. The electronically commutated motor according to claim 6, wherein the rotor base body forms a magnetic rotor return for the magnetization component of the rotor.

8. The electronically commutated motor according to claim 1, wherein:
a fan wheel is arranged at a first end of the rotor shaft; and
the fan wheel bears axially against a second end face, which is directed away from the first end face of the rotor, at least in some regions.

9. The electronically commutated motor according to claim 8, wherein a second end of the rotor shaft has at least one signal transmitter configured to detect the position of the rotor in relation to the stator.

10. The electronically commutated motor according to claim 1, wherein the electronically commutated motor is configured without a housing.

11. A hand-held power tool, comprising an electronically commutated motor according to claim 1.
